(19) United States
(12) Patent Application Publication
(10) Pub. No.: US 2026/0118020 A1
(43) Pub. Date: Apr. 30, 2026

(54) CRYOGENIC COOLING SYSTEM WITH MULTIPLE DILUTION UNITS

(71) Applicant: Bluefors Oy, Helsinki (FI)

(72) Inventors: Rob BLAAUWGEERS, Helsini (FI); Pieter VORSELMAN, Helsini (FI)

(73) Assignee: Bluefors Oy, Helsinki (FI)

(21) Appl. No.: 19/164,612

(22) PCT Filed: Apr. 10, 2024
(86) PCT No.: PCT/FI2024/050162

§ 371 Date: Sep. 12, 2025

(30) Foreign Application Priority Data
Apr. 12, 2023 (FI) 20235415

(51) Int. Cl. F25B 9/10; F25B 9/12

(52) U.S. Cl. CPC F25B 9/10; F25B 9/12

(57) ABSTRACT

Inside the vacuum enclosure (101) of a cryostat, a plurality of temperature stages form an ordered series in a primary direction. They are cooled to respective cryogenically cooled temperatures with stages (104, 106) of a staged cooling system. A first dilution refrigerator (1001) comprises a first still (109) and a first mixing chamber (110), of which said first still (109) is located on a first still flange (501) and said first mixing chamber (110) is located on a first mixing chamber flange (502). A second dilution refrigerator (1002) comprises a second still (301) and a second mixing chamber (302), of which said second still (301) is located on a second still flange (504) and said second mixing chamber (302) is located on a second mixing chamber flange (505). Said first still flange (501) is thermally separate from said second still flange (504). Said first mixing chamber flange (502) is thermally separate from said second mixing chamber flange (505). Said second dilution refrigerator (1002) is configured for a larger cooling power than said first dilution refrigerator (1001).

### FIELD OF THE INVENTION

The invention is generally related to the cooling of cryostats. In particular, the invention is related to structural solutions and refrigeration mechanisms that enable cooling a cryostat efficiently, with reasonable consequences in structural complexity.

### BACKGROUND OF THE INVENTION

Early cryostats were cooled with liquid cryogens, such as liquid nitrogen and liquid helium. Later, mechanical cooling devices such as Stirling cryocoolers, Gifford-McMahon coolers, Pulse Tube Refrigerators (PTRs), and Joule-Thomson coolers have been introduced to implement so-called cryogen-free cooling. If the core part of the cryostat comprises a further cooling system such as a dilution refrigerator, which only becomes operative at temperatures at and below about 4 K, the required pre-cooling may be made with for example a PTR. In a typical case, the PTR has two cooling stages, of which the first stage is used to achieve a temperature around 50-70 K and the second stage pre-cools the still of the dilution refrigerator to the required 4 K level.

Following the stage-wise structure of the refrigeration system, the whole cryostat typically comprises temperature stages built as flanges parallel to each other and displaced from each other in the perpendicular direction. In many cases said perpendicular direction is the vertical direction. A top plate of the cryostat may constitute a room temperature flange, below which are a 50 K flange cooled by the first stage of the PTR, a 4 K flange cooled by the second stage of the PTR, as well as further, consecutively colder flanges down to the target region cooled by the mixing chamber of the dilution refrigerator. Radiation shields, each thermally coupled to the respective temperature stage, form a nested structure in which colder temperature stages may be surrounded by the radiation shield of the previous warmer temperature stage. The purpose of the radiation shields is to reduce the heat load to the colder parts inside, by intercepting radiated heat from warmer parts outside and conducting it to the respective part of the refrigeration system.

FIG. 1 is a simplified schematic illustration of a cryostat that is equipped with a dilution refrigerator and a mechanical pre-cooler. The outermost structure of the cryostat is a vacuum enclosure 101, which is shown with dashed lines in FIG. 1. The topmost flange 102 is the lid of the vacuum enclosure. The room temperature stage 103 of the mechanical pre-cooler is attached thereto. The first stage 104 of the mechanical pre-cooler is attached to a first flange 105 and the second stage 106 of the mechanical pre-cooler is attached to a second flange 107. The first and second flanges may be called the 50 K flange and the 4 K flange for example, reflecting their temperatures during operation.

Further below there are more flanges, like the still flange 108 to which the still 109 of the dilution refrigerator is attached. In FIG. 1 the mixing chamber 110 of the dilution refrigerator is attached to the base temperature flange 111. Reference designator 112 illustrates the target region for a payload that is to be refrigerated. The payload is frequently referred to as the sample, and it should be firmly attached to the base temperature flange 111 in order to ensure as good thermal conductance as possible.

Radiation shields, which are not shown in FIG. 1 for graphical clarity, are typically cylindrical and attached to the flanges in a nested configuration. The structure may comprise other, intermediate flanges like a so-called 100 mK flange between the still flange 108 and the base temperature flange 111. Aligned apertures may exist in the flanges to provide, together with a cover 113 at the top, a so-called line-of-sight port to the target region 112.

The dilution refrigerator has a certain cooling power with which to cool the target region. In many technical fields that require cryogenic cooling, such as quantum computing for example, there is a clear tendency towards larger and larger setups that may dissipate more power at or close to the target region as well as at the higher temperature stages of the cryostat, consequently requiring more cooling power. Basically, it is possible to increase the cooling power of a dilution refrigerator by intensifying the circulation of 3He. However, inevitable physical facts such as the (in-herently relatively large) flow resistance of liquid 3He mean that simultaneously the achievable base temperature rises. In short, increased cooling power and lowest possible base temperature tend to be mutually contradicting aims.

### SUMMARY

It is an objective to present a cryostat and a method for cooling a cryostat that solve the problem of larger heat loads in an advantageous and technically straightforward way. Another objective is to ensure that the solution is scalable towards even larger cryostats. A further objective is to solve the problem of increased heat loads without sacrificing reliability in operation. A yet further objective is to combine effective cooling with only a reasonable increase in structural complicatedness.

These and further advantageous objectives are achieved by equipping the cryostat with two differently dimensioned or configured dilution refrigerators and separating their operation suitably so that they may serve different purposes regarding cooling power and base temperature.

According to an embodiment, there is provided a cryostat that comprises a vacuum enclosure. Inside said vacuum enclosure are a plurality of temperature stages arranged as an ordered series of flanges in a primary direction of the cryostat, to be cooled to respective cryogenically cooled temperatures. Stages of a staged cooling system are thermally coupled with and configured to cool respective ones of said plurality of temperature stages. The cryostat comprises a first dilution refrigerator, comprising a first still and a first mixing chamber, of which said first still is located on a first still flange and said first mixing chamber is located on a first mixing chamber flange. Said first still flange and first mixing chamber flange are among the ordered series of flanges that are comprised in said plurality of temperature stages. The cryostat comprises a second dilution refrigerator, comprising a second still and a second mixing chamber, of which said second still is located on a second still flange and said second mixing chamber is located on a second mixing chamber flange. Said second still flange and second mixing chamber flange are among the ordered series of flanges that are comprised in said plurality of temperature stages. Said first still flange is thermally separate from said second still flange. Said first mixing chamber flange is thermally separate from said second mixing chamber flange. Said second dilution refrigerator is configured for a larger cooling power than said first dilution refrigerator.

According to an embodiment, in said ordered series, said first still flange is displaced in said primary direction from said second still flange. This involves at least the advantage that there may be more space available for any or both of the first and second still flanges.

According to an embodiment, in said ordered series, said first mixing chamber flange is displaced in said primary direction from said second mixing chamber flange. This involves at least the advantage that there may be more space available for any or both of the first and second mixing chamber flanges.

According to an embodiment, said second mixing chamber flange defines a first toroidal spatial region with a first bore, and said first mixing chamber flange is at least partially located within said first bore or its spatial extension in the axial direction of said first bore. This involves at least the advantage that the second mixing chamber flange or parts thereof may be used as radiation shields for shielding the first mixing chamber flange or parts thereof.

According to an embodiment, said second still flange defines a second toroidal spatial region with a second bore, and said first still flange is at least partially located within said second bore or its spatial extension in the axial direction of said second bore. This involves at least the advantage of relative structural simplicity.

According to an embodiment, the cryostat comprises one or more signal lines for arranging communications with one or more samples to be located on one or both of said first and second mixing chamber flanges. There may then be one or more thermalization points for thermalizing at least a subset of said one or more signal lines. Said one or more thermalization points may be located at on least one of the following: the first still flange, the second still flange, the first mixing chamber flange, the second mixing chamber flange. This involves at least the advantage that heat loads posed on the coldest stage(s) by the signal lines may be reduced.

According to an embodiment, the cryostat comprises signal connectors on at least one of said first and second mixing chamber flanges for facilitating the coupling of said one or more samples with said one or more signal lines. This involves at least the advantage of relatively simple wiring of samples for experiments and other kinds of operation.

According to an embodiment, the cryostat comprises a first gas handling subsystem for the first dilution refrigerator and a second gas handling subsystem for the second dilution refrigerator. The second gas handling subsystem may then comprise at least one functional component that is not part of the first gas handling subsystem. This involves at least the advantage that the first and second dilution refrigerators may be made to operate relatively independently of each other.

According to an embodiment, the first gas handling subsystem comprises a first circulation pump configured to circulate operational fluid through the first dilution refrigerator. The second gas handling subsystem may then comprise a second circulation pump, different from said first circulation pump, configured to circulate operational fluid through the second dilution refrigerator. This involves at least the advantage that different flow rates can be maintained through the first and second dilution refrigerators.

According to a second aspect, there is provided a method for cooling a cryostat. The method comprises, inside a vacuum enclosure, cooling a plurality of temperature stages, arranged as an ordered series of flanges in a primary direction of the cryostat, to respective cryogenically cooled temperatures using a staged cooling system. Stages thereof are thermally coupled with and configured to cool respective ones of said plurality of temperature stages. The method comprises using a first dilution refrigerator, comprising a first still and a first mixing chamber, to cool a first mixing chamber flange on which said first mixing chamber is located. Said first mixing chamber flange is among the ordered series of flanges that are comprised in said plurality of temperature stages. The method comprises using a second dilution refrigerator, comprising a second still and a second mixing chamber, to cool a second mixing chamber flange on which said second mixing chamber is located. Said second mixing chamber stage is among the ordered series of flanges that are comprised in said plurality of temperature stages. The method comprises maintaining a first still flange, on which said first still is located, thermally separate from a second still flange, on which the second still is located. The method comprises maintaining said first mixing chamber flange thermally separate from said second mixing chamber flange, and operating said second dilution refrigerator at a larger cooling power than said first dilution refrigerator, resulting in a temperature of said second mixing chamber being higher than the temperature of the first mixing chamber.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a cryostat with cryogen-free cooling according to known technology,

FIG. 2 is a schematic representation of the cryostat of FIG. 1,

FIG. 3 illustrates schematically a cryostat with two dilution refrigerators,

FIG. 4 illustrates schematically a cryostat with two dilution refrigerators,

FIG. 5 illustrates schematically a cryostat with two dilution refrigerators,

FIG. 6 illustrates schematically a cryostat with two dilution refrigerators,

FIG. 7 illustrates schematically a cryostat with two dilution refrigerators,

FIG. 8 illustrates schematically a cryostat with two dilution refrigerators,

FIG. 9 illustrates schematically a cryostat with two dilution refrigerators, and

FIG. 10 illustrates parts of a cryostat according to an embodiment.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

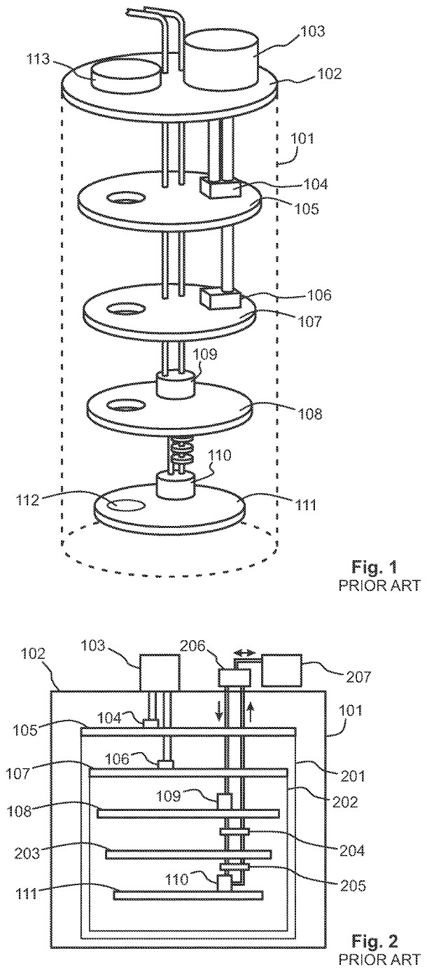

In order to facilitate more straightforward comparison, FIG. 2 provides a further simplified schematic illustration of a previously known cryostat equipped with a dilution refrigerator. Parts corresponding to those shown in FIG. 1 are the vacuum enclosure 101; the top (room temperature) flange 102; the room temperature part 103, first stage 104, and second stage 106 of the mechanical pre-cooler; the 50 K flange 105; the 4 K flange 107; the still flange 108; the mixing chamber flange 111; and the still 109 and mixing chamber 110 of the dilution refrigerator. Also schematically shown in FIG. 2 are the two outmost radiation shields 201 and 202 and the 100 mK flange 203, as well as examples of heat exchangers 204 and 205 that may appear on various levels as parts of the dilution refrigerator. Above the top flange 102 in FIG. 2 are the gas handling subsystem of the dilution refrigerator, of which a circulation pump 206 and mixture dump 207 are separately shown in FIG. 2.

For systematic reference, the flanges 105, 107, 108, 203, and 111 inside the vacuum enclosure 101 may be characterized as a plurality of temperature stages arranged in an ordered series in a primary direction of the cryostat, to be cooled to respective cryogenically cooled temperatures. In this case, the primary direction is the vertical direction, but in general, both in prior art and in the solutions discussed in this text, the primary direction may also refer to a direction towards the coldest part of the cryostat, irrespective of geometry or orientation. The mechanical pre-cooler may be characterized as a staged cooling system, stages of which are thermally coupled with and configured to cool respective ones of said plurality of temperature stages. The still flange 108 and mixing chamber flange 111 may also be called the still stage and mixing chamber stage, respectively.

Cryostats may comprise many more parts than those shown in the schematical illustration of FIG. 2. For example, heat switches are needed between the various stages in order to control the thermal conductivity between the stages. When a warm cryostat of this kind is first started, heat switches between the temperature stages 107, 108, 203, and 111 must be thermally conductive because the stages 104 and 106 of the staged cooling system are initially the only means available to cool also the lower temperature stages. After the starting temperature (around 4 K) of the dilution refrigerator has been reached, said heat switches must be made thermally insulating so that it becomes possible to make the lowest temperature stages achieve and maintain their desired temperatures through operation of the dilution refrigerator.

Additionally, the routing of the helium circulation lines for the dilution refrigerator is typically more complicated than what is illustrated schematically in FIG. 2. For example, the ingoing (condensing) line may be interconnected with the parts and stages of the mechanical pre-cooler for making the mechanical pre-cooler cool the ingoing helium mixture. In this and subsequent descriptions of embodiments such details of construction that have little significance to the invention are omitted for maintaining clarity.

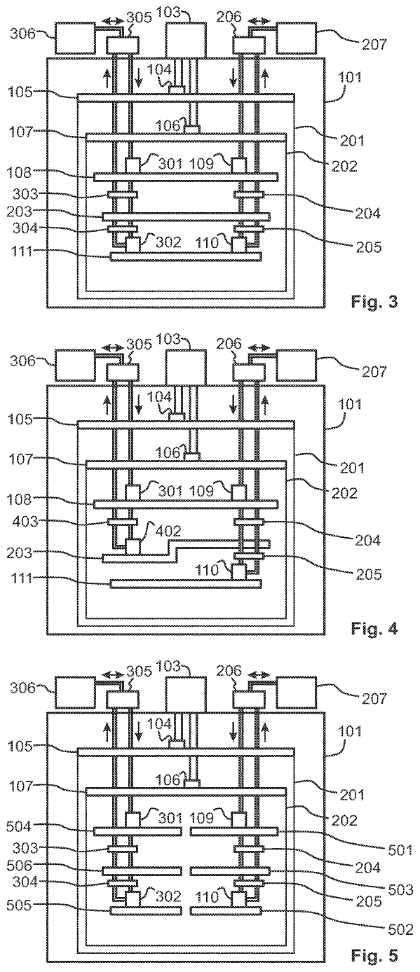

FIG. 3 illustrates a cryostat that comprises a vacuum enclosure 101 and, inside the vacuum enclosure, a plurality of temperature stages 105, 107, 108, 203, and 111 arranged in an ordered series in a primary direction of the cryostat. Said temperature stages are to be cooled to respective cryogenically cooled temperatures during normal operation of the cryostat. In the upper middle part of FIG. 3 is a staged cooling system, stages 104 and 106 of which are thermally coupled with and configured to cool respective ones of said plurality of temperature stages, namely stages 105 and 107. In this schematic example, the staged cooling system has been drawn with certain resemblance to pulse tubes as known at the time of writing this text. It is to be noted, however, that in this and subsequent embodiments, the disclosure is not limited to pulse tubes as staged cooling systems. Other alternatives include, but are not limited to, Joule-Thomson coolers, Gifford-McMahon coolers, and even “wet” cooling systems based on liquid cryogens. Example of cooling systems based on liquid cryogens include, but are not limited to, liquid cryogen baths and circulation of cooled, gaseous or liquid cryogens through piping.

The cryostat of FIG. 3 comprises two dilution refrigerators. The one on the right may be called the first dilution refrigerator for the ease of unambiguous reference. It comprises a first still 109 and a first mixing chamber 110, of which the first still 109 is located on the middle temperature stage 108, also called here the still stage. The first mixing chamber 110 is located on the lowest temperature stage 111, also called here the mixing chamber stage.

The dilution refrigerator on the left in FIG. 3 may be called the second dilution refrigerator. It comprises a second still 301 and a second mixing chamber 302. These are located on the same temperature stages as the respective parts of the first dilution refrigerator on the right: the second still 301 is located on the still stage (temperature stage 108) and the second mixing chamber 302 is located on the mixing chamber stage (temperature stage 111).

As the purpose of each temperature stage in the cryostat is to establish a temperature point during operation of the cryostat, they are made of material(s) of high thermal conductivity. In cryogenic technology, a high thermal conductivity may be for example at least 100 W/(m*K) at or above 10 K, at least 10 W/(m*K) at 1 K, at least 1 W/(m*K) at 0.1 K, or at least 0.1 W/(m*K) at 0.01 K. Consequently, in the cryostat of FIG. 3, the first still 109 will remain at essentially the same temperature as the second still 301, and the first mixing chamber 110 will remain at essentially the same temperature as the second mixing chamber 302. As a difference to the cryostat of FIG. 2, the cooling power at each of the still stage 108 and the mixing chamber stage 111 may in any case be higher, because both these temperature stages have now two parallelly operating cooling means of the type shown earlier in FIG. 2 coupled to them respectively.

FIG. 4 illustrates a cryostat that comprises a vacuum enclosure 101 and, inside the vacuum enclosure, a plurality of temperature stages 105, 107, 108, 203, and 111 arranged in an ordered series in a primary direction of the cryostat. Said temperature stages are to be cooled to respective cryogenically cooled temperatures during normal operation of the cryostat. Similar to FIG. 3, there is a staged cooling system, stages 104 and 106 of which are thermally coupled with and configured to cool respective ones of said plurality of temperature stages, namely stages 105 and 107.

The cryostat of FIG. 4 comprises two dilution refrigerators. The first dilution refrigerator on the right may be similar to the first dilution refrigerator of FIG. 3. It comprises a first still 109 and a first mixing chamber 110, of which the first still 109 is located on the middle temperature stage 108, also called here the still stage. The first mixing chamber 110 is located on the lowest temperature stage 111, also called here the mixing chamber stage.

The dilution refrigerator on the left in FIG. 4 may be called the second dilution refrigerator. It comprises a second still 301 and a second mixing chamber 402. The second still 301 is located on the still stage (temperature stage 108), i.e. on the same temperature stage as the first still 109. The second mixing chamber 402 is not located on the mixing chamber stage (temperature stage 111), but on an intermediate stage 203 between the still stage 108 and the mixing chamber stage 111. FIG. 4 shows only one (set of) heat exchanger(s) 403 between the second still 301 and the second mixing chamber 402, but-as in all of the accompanying drawings—this is just a schematical representation and does not limit the number or location of heat exchangers or other non-illustrated parts of the cryostat.

The intermediate stage 203, sometimes referred to as the 100 mK stage, serves as a second mixing chamber stage in FIG. 4. It is thermally separate from the (first) mixing chamber sage 111, which means that these two may have different temperatures. Being thermally separate means that the two stages are thermally insulated from each other, or at least in the design of the cryostat active measures have been taken to reduce the exchange of thermal energy between the two. Two parts of a cryostat that are thermally separate from each other will not reach, and are not configured to reach, thermal equilibrium during any typical running time of the cryostat. They may be for example structurally linked to each other through only materials of low thermal conductivity, or they may be linked to each other only through some third part of the cryostat so that at least one section of such an indirect link consists of materials of low thermal conductivity. In cryogenic technology, low thermal conductivity may be for example less than 50 W/(m*K) at 100 K, less than 5 W/(m*K) at 10 K, less than 0.75 W/(m*K) at 1 K, less than 0.075 W/(m*K) at 0.1 K, and less than 0.0075 W/(m*K) at 0.01 K.

In such an arrangement, if not all parts of the payload to be cooled in the cryostat require the lowest possible temperature, it may be possible to place the “warmer” parts of the payload on the second mixing chamber stage 203 and the “colder” parts of the payload on the first mixing chamber stage 111. Then, as the heat dissipated by the “warmer” parts does not thermally load the first mixing chamber stage 111, the last-mentioned may reach lower temperatures during operation than if the two mixing chamber stages were thermally coupled.

In the embodiment of FIG. 4, like in those of FIGS. 3 and 5-10, the first and second dilution refrigerators each have their own gas handling subsystem. The gas handling subsystem of the first dilution refrigerator comprises the circulation pump 206 and the mixture dump 207. The gas handling subsystem of the second dilution refrigerator comprises the circulation pump 305 and the mixture dump 306. It may be possible to share some components, like the mixture dump for example, between two or more gas handling subsystems. However, for purposes explained in more detail below, it is advantageous to have at least dedicated circulation pumps for each dilution refrigerator.

FIG. 5 illustrates a cryostat that comprises a vacuum enclosure 101 and, inside the vacuum enclosure, a plurality of temperature stages 105, 107, 501, 502, 503, 504, 505, and 506 arranged in an ordered series in a primary direction of the cryostat. Some of said temperature stages may coincide with each other in said primary direction of the cryostat, in which case such temperature stages may be said to occupy a common level in said ordered series. Said temperature stages are to be cooled to respective cryogenically cooled temperatures during normal operation of the cryostat. Similar to FIGS. 3 and 4, there is a staged cooling system, stages 104 and 106 of which are thermally coupled with and configured to cool respective ones of said plurality of temperature stages, namely stages 105 and 107.

The cryostat of FIG. 5 comprises two dilution refrigerators. The first dilution refrigerator on the right may be similar to the first dilution refrigerator of FIG. 3. It comprises a first still 109 and a first mixing chamber 110, of which the first still 109 is located on a first still stage 501. The first mixing chamber 110 is located on a first mixing chamber stage 502.

The dilution refrigerator on the left in FIG. 5 may be called the second dilution refrigerator. It comprises a second still 301 and a second mixing chamber 302. The second still 301 is located on a second still stage 504, which is thermally separate from the first still stage 501. The second mixing chamber 302 is located on a second mixing chamber stage 505, which is thermally separate from the first mixing chamber stage 502.

For the sake of example, FIG. 5 shows a first 100 mK stage 503 between the first still stage 501 and the first mixing chamber stage 502, and a second 100 mK stage 506 between the second still stage 504 and the second mixing chamber stage 505. Also for the sake of example, FIG. 5 shows two (sets of) heat exchangers both in the first dilution refrigerator (reference designators 204 and 205) and in the second dilution refrigerator (reference designators 303 and 304). Further radiation shields, heat switches, and other not illustrated parts may also be included in the cryostat.

The still stages 501 and 504 being thermally separate from each other allows them to have different temperatures during operation of the cryostat. Similarly, the mixing chamber stages 502 and 505 being thermally separate from each other allows them to have different temperatures during operation of the cryostat. Thus, functionally, the cryostat of FIG. 5 could be characterized by the still stages 501 and 504 having intentionally different temperatures, and/or the mixing chamber stages 502 and 505 having intentionally different temperatures, during operation.

In construction, the cryostat of FIG. 5 may be characterised as the second dilution refrigerator being configured for a larger cooling power than the first dilution refrigerator. Taken that a larger cooling power typically comes with higher temperatures, this characterisation conforms with the functional definition above.

Configuring a dilution refrigerator for a certain cooling power may be implemented through dimensioning, through predefined flow rates in the circulation of helium-3, or both, in a manner known as such to the person skilled in the art. As a basic rule, the cooling power of a dilution refrigerator is proportional to the circulation rate of 3He. Basically, cooling power can be increased by increasing the flow rate. However, at the lowest temperatures, viscous heating and imperfect heat exchange will negatively affect the achievable base temperature for large enough circulation rates.

A dilution refrigerator with large cooling power may be dimensioned to have large flow channels and large heat-exchanging surface. This means that it will need large amounts of rare and expensive 3He for operating. On the other hand, if one can accept the increase in achievable base temperature, a dilution refrigerator that was not specifically dimensioned for large circulation rates may be configured for larger cooling power at a (relatively) high temperature by simply increasing the flow rate, through additional heat applied at the still, as here viscous heating and heat-exchanging surface play less of a role.

Two dilution refrigerators that are configured for different cooling powers may be units of the same type only operated differently (i.e. configured for operation with different flow rates), or they may be different kinds of units. If such two dilution refrigerators are configured for operation with different flow rates, it is advantageous to have their gas handling subsystems separate from each other at least to the extent that each has its own circulation pump, because the circulation pump is the component responsible for setting and maintaining the flow rate.

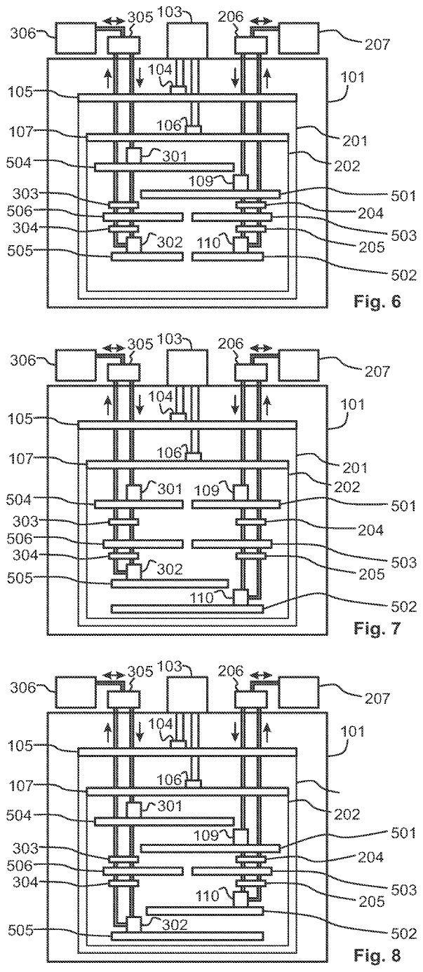

FIG. 6 illustrates a cryostat that comprises a vacuum enclosure 101 and, inside the vacuum enclosure, a plurality of temperature stages 105, 107, 501, 502, 503, 504, 505, and 506 arranged in an ordered series in a primary direction of the cryostat. Similar to FIG. 5, some of said temperature stages may coincide with each other in said primary direction of the cryostat, in which case such temperature stages may be said to occupy a common level in said ordered series. Said temperature stages are to be cooled to respective cryogenically cooled temperatures during normal operation of the cryostat. Similar to FIGS. 3 to 5, there is a staged cooling system, stages 104 and 106 of which are thermally coupled with and configured to cool respective ones of said plurality of temperature stages, namely stages 105 and 107.

The cryostat of FIG. 6 comprises two dilution refrigerators. The first dilution refrigerator on the right may be similar to the respective first dilution refrigerators of FIGS. 3 to 5. It comprises a first still 109 and a first mixing chamber 110, of which the first still 109 is located on a first still stage 501. The first mixing chamber 110 is located on a first mixing chamber stage 502.

The second dilution refrigerator on the left in FIG. 6 comprises a second still 301 and a second mixing chamber 302. The second still 301 is located on a second still stage 504, which is thermally separate from the first still stage 501. The second mixing chamber 302 is located on a second mixing chamber stage 505, which is thermally separate from the first mixing chamber stage 502. As a difference to FIG. 5, the first still stage 501 is displaced in said primary direction from the second still stage 504. In FIG. 6, the first still stage 501 is closer to the coldest parts of the cryostat in said primary direction than the second still stage 504.

For the sake of example, FIG. 6 shows a first 100 mK stage 503 between the first still stage 501 and the first mixing chamber stage 502, and a second 100 mK stage 506 between the second still stage 504 and the second mixing chamber stage 505. Also for the sake of example, FIG. 6 shows two (sets of) heat exchangers both in the first dilution refrigerator (reference designators 204 and 205) and in the second dilution refrigerator (reference designators 303 and 304). Further radiation shields, heat switches, and other not illustrated parts may also be included in the cryostat.

As above with reference to FIG. 5, also in FIG. 6 the still stages 501 and 504 may have different temperatures during operation of the cryostat and the mixing chamber stages 502 and 505 may have different temperatures during operation of the cryostat. Thus, functionally, the cryostat of FIG. 6 could be characterized by the still stages 501 and 504 having intentionally different temperatures, and/or the mixing chamber stages 502 and 505 having intentionally different temperatures, during operation. In construction, the cryostat of FIG. 6 may be characterised as the second dilution refrigerator being configured for a larger cooling power than the first dilution refrigerator.

FIG. 7 illustrates a cryostat that is quite similar to those of FIGS. 5 and 6 above. As a difference to FIG. 6, the first still stage 501 and the second still stage 504 are not displaced from each other in the primary direction the cryostat, but on the same level. As a difference to both FIGS. 5 and 6, the first mixing chamber stage 502 is displaced in said primary direction from the second mixing chamber stage 505. In this example the first mixing chamber stage 502 is further down in the vertical direction than the second mixing chamber stage 505. Taken that the first mixing chamber stage 502 is to be the coldest part of the cryostat, it could also be located above the second mixing chamber stage 505, if this helps to reduce the amount of radiated heat received by the first mixing chamber stage 502. That may be the case if, below both mixing chamber stages 502 and 505 in the vertical direction, there is e.g. a radiation shield or other structural part that during operation assumes a higher temperature than the second mixing chamber stage 505. Similar to FIGS. 5 and 6, the second dilution refrigerator in FIG. 7 is configured for a larger cooling power than the first dilution refrigerator.

FIG. 8 illustrates a cryostat that is quite similar to those of FIGS. 5 to 7 above. As a difference, the first still stage 501 and the second still stage 504 are displaced from each other in the primary direction and the first mixing chamber stage 502 and the second mixing chamber stage 505 are displaced from each other in the primary direction. Similar to FIGS. 5 to 7, the second dilution refrigerator in FIG. 8 is configured for a larger cooling power than the first dilution refrigerator.

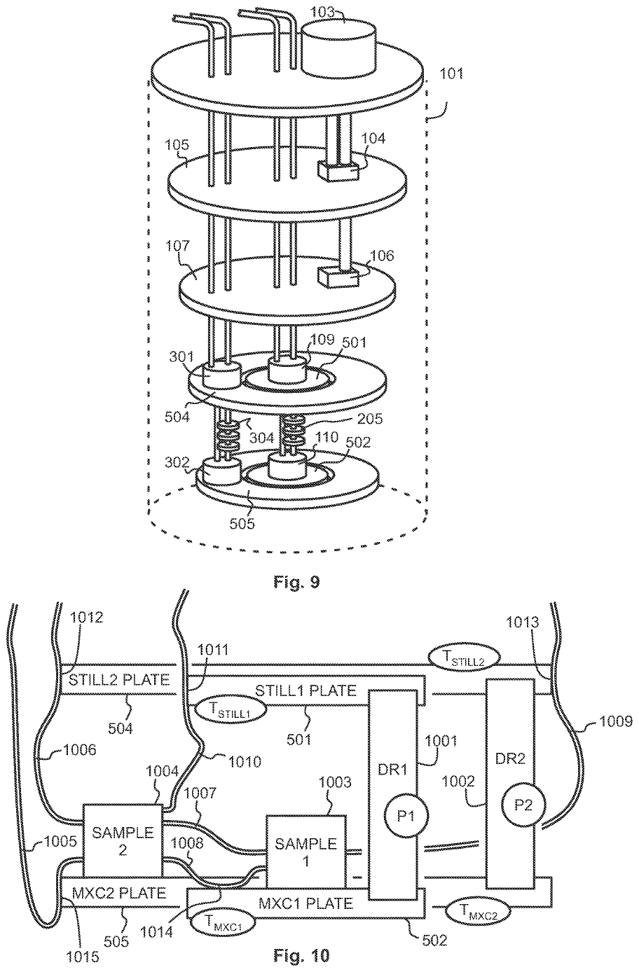

FIG. 9 illustrates a cryostat that comprises a vacuum enclosure 101 and, inside the vacuum enclosure, a plurality of temperature stages, of which stages 105, 107, 501, 502, 504, and 505 are shown. The temperature stages are arranged in an ordered series in a primary direction of the cryostat. Some of said temperature stages may coincide with each other in said primary direction of the cryostat, in which case such temperature stages may be said to occupy a common level in said ordered series. Said temperature stages are to be cooled to respective cryogenically cooled temperatures during normal operation of the cryostat. Similar to the previously described embodiments, there is a staged cooling system, stages 104 and 106 of which are thermally coupled with and configured to cool respective ones of said plurality of temperature stages, namely stages 105 and 107. Parts of the cryostat that have lesser importance to this description, such as heat shields, heat switches, structural supports, further temperature stages, and the like are not shown in FIG. 9.

The cryostat of FIG. 9 comprises two dilution refrigerators. The first dilution refrigerator in the middle comprises a first still 109 and a first mixing chamber 110, of which the first still 109 is located on a first still stage 501. The first mixing chamber 110 is located on a first mixing chamber stage 502. Heat exchangers 205 are shown as an example between the first still 109 and the first mixing chamber 110. There could be one or more further temperature stages, like a 100 mK stage for example, between the first still stage 501 and the first mixing chamber stage 502, but none are shown in FIG. 9 for reasons of graphical clarity.

The dilution refrigerator on the left in FIG. 9 may be called the second dilution refrigerator. It comprises a second still 301 and a second mixing chamber 302. The second still 301 is located on a second still stage 504, which is thermally separate from the first still stage 501. The second mixing chamber 302 is located on a second mixing chamber stage 505, which is thermally separate from the first mixing chamber stage 502. Heat exchangers 304 are shown as an example between the second still 301 and the second mixing chamber 302. There could be one or more further temperature stages, like a 100 mK stage for example, between the second still stage 504 and the second mixing chamber stage 505, but none are shown in FIG. 9 for reasons of graphical clarity.

The second mixing chamber stage 505 is generally ring-shaped. It may be said to define a (first) toroidal spatial region with a (first) bore. References to anything toroidal or bore-like should not be construed as requiring any kind of symmetry, but rather as covering any three-dimensional shape that surrounds an empty space. The bore means said empty space, i.e. a hole through such a three-dimensional shape. The bore may be located centrally or off-centre in relation to said three-dimensional shape. There may be one, two, or more such bores through said three-dimensional shape. In such a case, a reference to a bore in singular in this text should be construed to mean any individual bore or all such bores or a subset of all such bores.

The first mixing chamber stage 502 is at least partially located within said (first) bore. In other words, the first mixing chamber stage 502 fills a large portion of the empty space inside the ring-shaped second mixing chamber stage 505. This way the second mixing chamber stage 505 may be utilized as a partial radiation shield that partly surrounds the (colder) first mixing chamber stage 502 and thus reduces the heat load on the first mixing chamber 110, allowing the first mixing chamber 110 to reach a lower temperature than what would be possible without the shielding effect of the (partly) surrounding second mixing chamber stage 505.

If there are two or more bores defined by the second mixing chamber stage 505, there may be a first mixing chamber stage 502 in only one of them or there may be separate first mixing chamber stages in two or more of them.

The two still stages shown in FIG. 9 follow a similar geometry: the second still stage 504 defines a (second) toroidal spatial region with a (second) bore, and the first still stage 501 is at least partially located within said (second) bore. What was said about toroidal shapes and bores above applies also here. While some advantageous shielding effect may occur also here, a major advantage of making the still stages follow a similar geometry as the mixing chamber stages is the resulting relative simplicity in mechanical design. The two stills may be at different temperatures, in particular so that the second still 301 may be configured for operation at a higher temperature than the first still 109. This may reflect differences in dimensioning and/or flow rate; for example, the flow rate of 3He through the second still 301 may be larger than the flow rate of 3He through the first still 109.

The second dilution refrigerator is configured for a larger cooling power than the first dilution refrigerator in FIG. 9. Advantageous ways in which such a difference may be utilized are discussed next with reference to FIG. 10.

FIG. 10 illustrates schematically the two still stages 501 and 504, the two mixing chamber stages 502 and 505, and the two dilution refrigerators 1001 and 1002 of a cryostat. The second mixing chamber stage 505 defines a first toroidal spatial region with a first bore, so that the first mixing chamber stage 502 is at least partially located within said first bore or its spatial extension in the axial direction of said first bore. In this drawing, the axial direction of the bore is the vertical direction, and the first mixing chamber stage 502 is not on the same level as the second mixing chamber stage 505, hence the location “in the spatial extension in the axial direction of the first bore”. Similarly, in the example embodiment of FIG. 10, the second still stage 504 defines a second toroidal spatial region with a second bore, and the first still stage 501 is at least partially located within said second bore or its spatial extension in the axial direction of said second bore.

The first dilution refrigerator 1001 is configured for a cooling power P1, and the second dilution refrigerator 1002 is configured for a cooling power P2, which is larger than P1. As a result, during operation of the cryostat the first mixing chamber stage 502 assumes a temperature T_{MXC1} and the second mixing chamber stage 505 assumes a temperature T_{MXC2}, so that T_{MXC1}21 T_{MXC2}.

A further possible feature that is schematically shown in FIG. 10 is the provision of one or more samples to be located on one or both of the first 502 and second 505 mixing chamber stages. In FIG. 10, a first sample 1003 is located on and thermally coupled to the first mixing chamber stage 502 and a second sample 1004 is located on and thermally coupled to the second mixing chamber stage 505. Taken that—due to the structural geometry of the cryostat and the provision of the two dilution refrigerators, with their relative difference in cooling power—the first mixing chamber stage 502 will assume a lower temperature during operation than the second mixing chamber stage 505, it is advisable to include in the first sample 1003 such payload(s) that will benefit of the absolutely lowest achievable temperatures. Also taken the relatively difference in cooling power of the dilution refrigerators, it is advisable to include in the second sample 1004 such payload(s) or payload supporting component(s) and functionalities that do not necessarily require the coldest possible temperature during operation and/or that will cause significant dissipation of heat during operation. FIG. 10 show how the cryostat may comprise one or more signal lines for arranging communications with the one or more samples. Signal lines 1005, 1006, 1007, 1008, 1009, and 1010 are shown as examples. Additionally, the cryostat may comprise one or more thermalization points for thermalizing at least a subset of said one or more signal lines. Examples of thermalization points are shown in FIG. 10 located at the first still stage (thermalization point 1011), the second still stage (thermalization points 1012 and 1013), the first mixing chamber stage (thermalization point 1014), and the second mixing chamber stage (thermalization point 1015). Thermalization has the aim of conducting heat that may be generated in the signal lines and/or conducted along the signal lines from warmer parts of the cryostat to be intercepted and absorbed in the actively cooled parts of the cryostat.

A possibility that is not specifically shown in FIG. 10 but that may facilitate easier building of an experimental or operational set-up is the possible provision of signal connectors on the first 502 and/or second 505 mixing chamber stages. Such signal connectors may facilitate the coupling of one or more samples with one or more signal lines.

As with many of the preceding drawings, also FIG. 10 is a graphical simplification and omits possible further parts such as structural supports, heat switches, radiation shields, and the like that may be part of the working region and/or its close surroundings in a practical cryostat.

It is obvious to a person skilled in the art that with the advancement of technology, the basic idea of the invention may be implemented in various ways. As an example, while the description above consistently refers to two dilution refrigerators for simplicity and clarity, the cryostat may comprise more than two dilution refrigerators: any or both of the first and second dilution refrigerators described above may be doubled or multiplied to two or more similar, similarly operated and located units, and/or there may be a cascade of three or more dilution refrigerator stages, each dimensioned and configured for different cooling power and achievable temperature. The invention and its embodiments are thus not limited to the examples described above, instead they may vary within the scope of the claims.

1. A cryostat, comprising:
a vacuum enclosure;
a plurality of temperature stages inside said vacuum enclosure and arranged as an ordered series of flanges (105, 107, 108, 111, 203, 501, 502, 503, 504, 505, 506) in a primary direction of the cryostat, to be cooled to respective cryogenically cooled temperatures;
a staged cooling system, stages (104, 106) of which are thermally coupled with and configured to cool respective ones (105, 107) of said plurality of temperature stages; and
a first dilution refrigerator (1001), comprising a first still (109) and a first mixing chamber (110), of which said first still (109) is located on a first still flange (501) and said first mixing chamber (110) is located on a first mixing chamber flange (502), said first still flange (501) and first mixing chamber flange (502) being among the ordered series of flanges that are comprised in said plurality of temperature stages;
wherein the cryostat comprises a second dilution refrigerator (1002), comprising a second still (301) and a second mixing chamber (302), of which said second still (301) is located on a second still flange (504) and said second mixing chamber is located on a second mixing chamber flange (505), said second still flange (504) and second mixing chamber flange (505) being among the ordered series of flanges that are comprised in said plurality of temperature stages, said first still flange (501) is thermally separate from said second still flange (504), said first mixing chamber flange (502) is thermally separate from said second mixing chamber flange (505), and said second dilution refrigerator (1002) is configured for a larger cooling power than said first dilution refrigerator (1001).

2. A cryostat according to claim 1, wherein in said ordered series, said first still flange (501) is displaced in said primary direction from said second still flange (504).

3. A cryostat according to claim 1 or 2, wherein in said ordered series, said first mixing chamber flange (502) is displaced in said primary direction from said second mixing chamber flange (505).

4. A cryostat according to claim 1 wherein said second mixing chamber flange (505) defines a first toroidal spatial region with a first bore, and said first mixing chamber flange (502) is at least partially located within said first bore or its spatial extension in the axial direction of said first bore.

5. A cryostat according to claim 1 wherein said second still flange (504) defines a second toroidal spatial region with a second bore, and said first still flange (501) is at least partially located within said second bore or its spatial extension in the axial direction of said second bore.

6. A cryostat according to claim 1, comprising:
one or more signal lines (1005, 1006, 1007, 1008, 1009, 1010) for arranging communications with one or more samples (1003, 1004) to be located on one or both of said first (502) and second (505) mixing chamber flanges; and
one or more thermalization points (1011, 1012, 1013, 1014, 1015) for thermalizing at least a subset of said one or more signal lines (1005, 1006, 1007, 1008, 1009, 1010);
wherein said one or more thermalization points (1011, 1012, 1013, 1014, 1015) are located at on least one of the the first still flange (501), the second still flange (504), the first mixing chamber flange (502), and the second mixing chamber flange (505).

7. A cryostat according to claim 6, comprising signal connectors on at least one of said first (502) and second (505) mixing chamber flanges for facilitating the coupling of said one or more samples (1003, 1004) with said one or more signal lines (1005, 1006, 1007, 1008, 1009, 1010).

8. A cryostat according to claim 1 wherein the cryostat comprises a first gas handling subsystem (206, 207) for the first dilution refrigerator (1001) and a second gas handling subsystem (305, 306) for the second dilution refrigerator (1002), and the second gas handling subsystem (305, 306) comprises at least one functional component that is not part of the first gas handling subsystem (206, 207).

9. A cryostat according to claim 8, wherein the first gas handling subsystem (206, 207) comprises a first circulation pump (206) configured to circulate operational fluid through the first dilution refrigerator (1001), and the second gas handling subsystem (305, 306) comprises a second circulation pump (305), different from said first circulation pump (206), configured to circulate operational fluid through the second dilution refrigerator (1002).

10. A method for cooling a cryostat, the method comprising:
inside a vacuum enclosure (101), cooling a plurality of temperature stages, arranged as an ordered series of flanges (105, 107, 108, 111, 203, 501, 502, 503, 504, 505, 506) in a primary direction of the cryostat, to respective cryogenically cooled temperatures using a staged cooling system, stages (104, 106) of which are thermally coupled with and configured to cool respective ones (105, 107) of said plurality of temperature stages, and
using a first dilution refrigerator (1001), comprising a first still (109) and a first mixing chamber (110), to cool a first mixing chamber flange (502) on which said first mixing chamber (110) is located, said first mixing chamber flange (502) being among the ordered series of flanges that are comprised in said plurality of temperature stages;
using a second dilution refrigerator (1002), comprising a second still (301) and a second mixing chamber (302), to cool a second mixing chamber flange (505) on which said second mixing chamber (302) is located, said second mixing chamber flange (505) being among the ordered series of flanges that are comprised in said plurality of temperature stages;
maintaining a first still flange (501), on which said first still (109) is located, thermally separate from a second still flange (504), on which the second still (301) is located;
the maintaining said first mixing chamber flange (502) thermally separate from said second mixing chamber flange (505); and
wherein said second dilution refrigerator (1002) is operated at a larger cooling power than said first dilution refrigerator (1001), resulting in a temperature of said second mixing chamber (302) being higher than the temperature of the first mixing chamber (110).
